(19) United States
(12) Patent Application Publication
(10) Pub. No.: US 2026/0273861 A1
(43) Pub. Date: Sep. 17, 2026

(54) PRECISION 3D PRINTING FOR SECURE KNOT FORMATION AROUND STRUCTURAL COMPONENTS

(71) Applicant: INTERNATIONAL BUSINESS MACHINES CORPORATION, ARMONK, NY (US)

(72) Inventors: NEIL DELIMA, Scarborough (CA); Sarbajit Kumar Rakshit, Kolkata (IN); Carolina Garcia Delgado, Zapopan (MX); Martin G. Keen, Cary, NC (US)

(21) Appl. No.: 19/076,456

(22) Filed: Mar. 11, 2025

(51) Int. Cl. B29C 64/393; B29C 64/379; B33Y 10/00; B33Y 40/00; B33Y 50/02; B33Y 80/00

(52) U.S. Cl. CPC B29C 64/393; B29C 64/379; B33Y 10/00; B33Y 40/00; B33Y 50/02; B33Y 80/00

(57) ABSTRACT

According to at least one embodiment, a method, computer system, and computer program product for 3D-printing a knot to fasten two components together is provided. The present invention may include analyzing, by one or more sensors, a plurality of components to create component data; identifying an intersection at a critical point where force transfer occurs between two interfacing components; calculating a counterforce at an intersection of the components based on the component data; selecting a knot configuration based on the component data; and printing, by a knot printing device, the knot configuration onto the intersection of the components using an additive manufacturing process.

### BACKGROUND

The present invention relates, generally, to the field of computing, and more particularly to additive manufacturing.

The field of additive manufacturing, or 3D printing, relates to a variety of processes whereby three-dimensional objects are constructed by depositing, joining, or solidifying successive layers of material. These processes are controlled by a computer, which constructs the model according to a CAD model or other 3D digital model. Unlike traditional manufacturing, additive manufacturing allows intricate structures to be produced cheaply and accurately, without the need for any more infrastructure than a 3D printer and the materials to feed it. As the precision, consistency, and material range of 3D printing increases, so too does the range of applications, from functional or aesthetic prototyping to industrial production, health, and education.

### SUMMARY

According to at least one embodiment, a method, computer system, and computer program product for 3D-printing a knot to fasten two components together is provided. The present invention may include analyzing, by one or more sensors, a plurality of components to create component data; identifying an intersection at a critical point where force transfer occurs between two interfacing components; calculating a counterforce at an intersection of the components based on the component data; selecting a knot configuration based on the component data; and printing, by a knot printing device, the knot configuration onto the intersection of the components using an additive manufacturing process.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a knot-printing process according to at least one embodiment; and

FIG. 3 illustrates an exemplary knot printing device according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to additive manufacturing. The following described exemplary embodiments provide a system, method, and program product to, among other things, perform an analysis on two components to identify the number, type, circumference, and/or material of knots necessary to fasten the components together, and 3D-printing one or more knots onto the components.

As previously described, additive manufacturing relates to a process whereby a manufacturing material is deposited, joined, or solidified layer by layer onto a substrate or onto previously completed layers to produce a three-dimensional object. One of the key advantages of 3D printing is the ability to produce very complex shapes or geometries that would be otherwise impossible to construct by hand, including hollow parts or parts with internal truss structures to reduce weight.

However, in the realm of construction and engineering, the assembly of 3D structural components, particularly with respect to establishing secure and reliable connections between 3D-printed components, presents a considerable challenge. Traditional methods of fastening 3D-printed components often employ hardware or adhesives that may not provide the necessary adaptability or strength, especially in dynamic environments where thermal variations and material stresses are prevalent. Conventional fastening methods often do not account for the thermal expansion and contraction of materials, leading to potential loosening or failure. As such, there is a need in the art for a fastening solution that can withstand various environmental factors such as wind, moisture, and thermal cycling; a solution that can adapt to both static and dynamic loads without compromising the security of the fastened joint.

The solution may lie with 3D-printed knots. Using a 3D-printed knot to secure two 3D-printed components together offers several advantages over commonly used fastening means such as hardware or adhesives; knots are flexible, and can adapt to thermal changes in a way that rigid fasteners can't match. Additionally, the knot's design can be customized to fit specific geometries, ensuring a secure connection tailored to the assembly's needs. Unlike adhesives, which create a permanent bond, a 3D-printed knot can allow for non-destructive disassembly, making repairs or modifications easier. Knots offer advantages over rigid fasteners in a range of contexts, including situations where thermal cycling occurs, such as in aerospace components, situations where biocompatible connections are desired, such as medical implants, and complex architectural structures where traditional fasteners can't reach effectively.

However, 3D-printed knots pose their own challenges; a 3D-printed knot may not provide the same level of mechanical strength as metal screws or industrial adhesives, particularly under high loads or stress conditions. Printed materials, especially if not optimized for strength, can suffer from layer adhesion issues, making the knot prone to breaking under tension. Additionally, knots rely on friction and compression to stay in place, which can be less reliable over time. The assembly process may also require more precision to ensure the knot fits correctly and functions as intended. Thus, while a 3D-printed knot can be an innovative and material-efficient solution, its effectiveness depends on the specific application and required load-bearing capacity; to succeed, any method of employing 3D printed knots would need to ensure that the knots maintain their integrity under different loads and environmental conditions, and achieve the required gripping strength for structural stability over time.

As such, it may be advantageous to, among other things, implement a system that performs a visual analysis of the 3D-printed components to be connected, calculate the counterforce that a knot would have to generate to connect the two components based on the materials of the 3D printed components and the materials of the knot, select a type, number, and geometry of knot based on the counterforce, select a thickness of knot material based on the counterforce, and create the selected knots around the 3D components using, for example, specialized 3D-printing nozzles and/or a robotic system to hold the structural components during knot solidification. Therefore, the present embodiment has the capacity to improve the technical field of additive manufacturing by introducing the capability to 3D-print knots onto 3D-printed components to securely fasten them together, and where the 3D-printed knot's design can be customized to fit specific geometries that might not lend themselves well to hardware-based connectors or adhesives, ensuring a secure connection tailored to the assembly's needs which can be non-destructively disassembled, facilitating easier repairs and modifications. By calculating an optimal thickness or diameter of the knot material based on the required counterforce, selecting materials with appropriate thermal expansion properties, determining the optimal number of wraps needed for the knot, and adding a safety margin to the calculations, such a system would create a knot that maintains integrity sufficient to overcome any potential layer adhesion weaknesses.

According to at least one embodiment, the invention is a method for fastening two 3D-printed components together by analyzing the 3D-printed components to identify component data including the material properties, force components acting on the 3D-printed components, environmental conditions, and geometry of the 3D-printed components; calculate a required counterforce based on the component data; choose one or more appropriate knots based on the component data and the counterforce; and 3D-print the knot to apply the required counterforce to fasten the 3D-printed components together.

According to at least one embodiment, the invention is a system for fastening two 3D-printed components together comprising a knot printing device and a holding system, the system configured to perform a method of analyzing, using one or more sensors, the 3D-printed components to identify component data including the material properties, force components acting on the 3D-printed components, environmental conditions, and geometry of the 3D-printed components; calculating a required counterforce based on the component data; choose one or more appropriate knots based on the component data and the counterforce; and 3D-printing the knot, using the knot printing device, to apply the required counterforce to fasten the 3D-printed components together.

In at least one or more embodiments, the system may additionally comprise a robotic holding system to securely hold the 3D-printed components in place until the knot achieves the required gripping strength. The robotic holding system must be dynamic rather than static, as opposed to, for example, vices or clamps, because the robotic holding system must be able to adjust its grip as the knot cools and contracts; the components must be held in perfect alignment during the cooling phase (when the knot achieves its final grip strength) which a static system couldn't guarantee. As such, the robotic holding system may consist of articulated arms equipped with force-feedback sensors that can dynamically respond to the changing tensions as the knot solidifies.

References in the specification to “one embodiment,” “other embodiment,” “another embodiment,” “an embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to affect such feature, structure, or characteristic in connection with other embodiments whether or not explicitly described.

For purposes of the description hereinafter, the terms “upper”, “lower”, “right”, “left”, “vertical”, “horizontal”, “top”, “bottom”, and derivatives thereof shall relate to the disclosed structures and methods, as oriented in the drawing figures. The terms “overlying,” “atop,” “over,” “on,” “positioned on” or “positioned atop” mean that a first element is present on a second element wherein intervening elements, such as an interface structure, may be present between the first element and the second element. The term “direct contact” means that a first element and a second element are connected without any intermediary conducting, insulating, or semiconductor layers at the interface of the two elements.

In the interest of not obscuring the presentation of the embodiments of the present invention, in the following detailed description, some of the processing steps, materials, or operations that are known in the art may have been combined together for presentation and for illustration purposes and in some instances may not have been described in detail. Additionally, for brevity and maintaining a focus on distinctive features of elements of the present invention, description of previously discussed materials, processes, and structures may not be repeated with regard to subsequent Figures. In other instances, some processing steps or operations that are known may not be described. It should be understood that the following description is rather focused on the distinctive features or elements of the various embodiments of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to perform an analysis on two components to identify the number, type, circumference, and/or material of knots necessary to fasten the components together, and 3D-printing one or more knots onto the components.

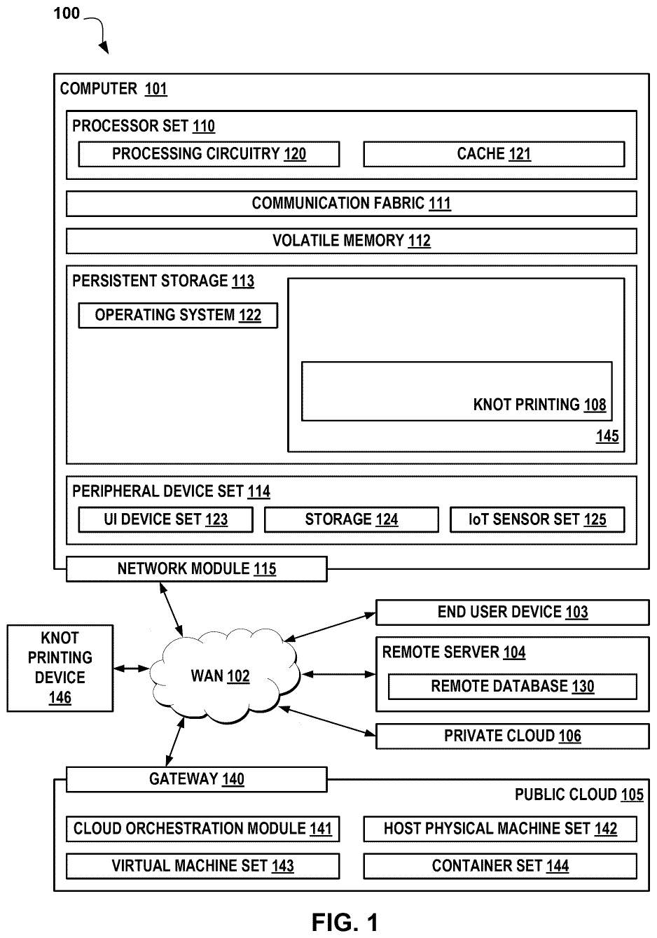

Referring now to FIG. 1, computing environment 100 contains an example of an environment for the execution of at least some of the computer code involved in performing the inventive methods, such as code block 145, which may comprise knot-printing program 108. In addition to code block 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 145, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented/processor-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 145 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a camera.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

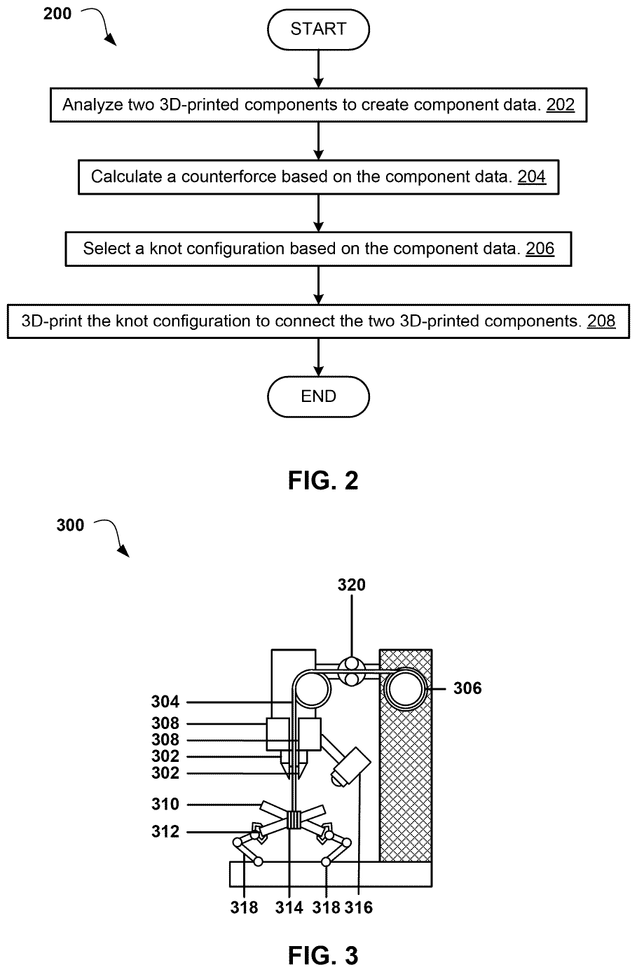

According to the present embodiment, the knot printing device 146 may be an additive manufacturing machine capable of executing a knot-printing process to print a three-dimensional knot onto two components to fasten them together. The knot-printing process may be explained in greater detail below with respect to FIG. 2. The knot printing device 146 may be a specialized 3D-printer equipped with a flexible, multi-axis print head that is capable of moving around objects in space in order to, for example, circumnavigate a 3D-structure to encircle the structure with a 3D-printed knot; as such, the knot printing device 146 may be equipped with a an articulated multi-jointed mounting which may enable the print head to freely move around the components to 3D-print the complex geometries of a knot. The knot printing device 146 may be distinct from traditional fixed-bed 3D printers in that traditional 3D printers are designed to print on a flat plane, not circumnavigate a 3D structure.

In embodiments, the knot printing device 146 may comprise multiple print heads, where the print heads are each equipped with nozzles of different diameters, such that the multiple print heads have nozzles in a range of diameters to accommodate filaments of different thicknesses; the knot-printing program 108 may select one or more of the print heads to use based on the required thickness of the knot. In embodiments, the knot printing device 146 may comprise one or more print heads equipped with flexible nozzles that may be operated to expand or contract in diameter, to dynamically accommodate different filament thicknesses. The knot printing device 146 may further comprise a material exchange system similar to multi-material 3D printers that allows the knot printing device 146 to swap materials being fed into a one or more of the print heads comprising the knot printing device 146, so that the knot printing device 146 may dynamically swap between filaments of multiple different thicknesses based on the required thickness of the knot. In embodiments, for example where the knot printing device 146 comprises multiple print heads, multiple print heads may be attached to an articulated mounting such that each print head with an articulated mounting is capable of moving in a 360-degree arc around the intersection, or such that the one or more print heads have a range of motion that is individually than 360-degrees around the intersection, but which collectively amount to a 360-degree arc of motion around the intersection.

In embodiments, the knot printing device 146 may comprise a robotic holding system, which may comprise multiple articulated robotic arms equipped to dynamically change position based on input from force-feedback sensors in order to adjust grip strength and position to react to the changing tensions in the knot as it cools and solidifies. The knot printing device 146 may be operated by, receive commands from, or otherwise be in communication with knot-printing program 108. In embodiments, the print head may be stationary, capable of limited motion, or capable of less than a 360-degree arc of motion around the intersection, but the robotic arms may be configured to move the components around relative to the print head such that the knot printing device 146 can print the knot around the entire circumference of the outer surfaces of the intersection. The knot printing device 146 may be explained in greater detail below with respect to FIG. 3.

According to the present embodiment, the knot-printing program 108 may be a program enabled to perform an analysis on two components to identify the number, type, circumference, and/or material of knots necessary to fasten the components together, and 3D-printing one or more knots onto the components. The knot-printing program 108 may, when executed, cause the computing environment 100 to carry out a knot-printing process 200. The knot-printing process 200 may be explained in further detail below with respect to FIG. 2. In embodiments of the invention, the knot-printing program 108 may be stored and/or run within or by any number or combination of devices including computer 101, end user device 103, remote server 104, private cloud 106, and/or public cloud 105, peripheral device set 114, and/or on any other device connected to WAN 102. Furthermore, knot-printing program 108 may be distributed in its operation over any number or combination of the aforementioned devices.

Referring now to FIG. 2, an operational flowchart illustrating a knot-printing process 200 is depicted according to at least one embodiment. At 202, the knot-printing program 108 may analyze two 3D-printed components to create component data. Here, the knot-printing program 108 may perform an analysis of the structural components to be fastened to identify component data. The knot-printing program 108 may utilize processing techniques such as computer vision techniques to analyze sensor data of the two or more components. The sensor data may be data on the components recorded as the components are held in or on the knot printing device 146, for instance held within a robotic holding system or other holding means integrated into the knot printing device 146 in the position it will be when the knot is applied, and/or recorded dynamically prior to or during the period of time where the knot is being actively printed. The sensor data may be recorded by one or more sensors integrated into the knot printing device and/or disposed within the environment of the knot printing device such that the sensors are still capable of directly recording data on the components; in embodiments, sensors may be disposed both in the knot printing device and in the environment, so as to acquire sensor data from two or more different angles, for example to record sensor data on all surfaces of the components comprising the one or more intersections where a knot is to be printed. In embodiments, the sensors may be disposed to record data at enough different angles to provide 360-degree sensor coverage of the one or more intersections, which may include direct visual feedback from multiple cameras, and which may be recorded in real time as the knot is being printed. In embodiments, the sensors may comprise visual cameras, infrared cameras, force feedback sensors, lidar, sonar, laser rangefinders, et cetera. Component data may be any sensor data or information inferred or calculated based on the sensor data that describes the physical properties of the two components to be joined and any forces acting upon them.

In embodiments, the component data may include material properties. The knot-printing program 108 may be pre-provided with a materials database or document that stores properties of different materials, such as visual properties, a material's thermal expansion coefficient, ductility, tensile and compressive strength, modulus of elasticity, et cetera. The knot-printing program 108 may use machine vision techniques to identify materials by matching visual properties of the components against the materials database; once a match is found, the knot-printing program 108 may extract the material properties corresponding to the identified material and integrate them into the component data. The knot-printing program 108 may use machine vision techniques to identify the geometry of the components, their shape, position relative to each other, et cetera, and may incorporate such into the component data.

In embodiments, the component data may include force components, which may include the various forces acting on the components; these forces may include the downward forces imposed by gravity, including rotational and/or angular forces resulting from the geometry of the components and their position relative to each other as well as the weight of the components and any payload they might be supporting; environmental forces such as wind, rain, snow, et cetera that the components may have to endure, forces such as thermal expansion and compression, as well as the elastic forces exerted by the components as a product of their material properties such as tensile and compressive strength, elasticity, ductility, et cetera. Potential environmental forces and/or temperatures in the one or more areas where the component may be deployed and which the component may be subjected to upon deployment may be pre-provided to the knot-printing program 108. The knot-printing program 108 may analyze the material properties, and estimate the weight of the components, which may be the gravitational force acting on the structure comprising the components due to its own mass. The knot-printing program 108 may identify the payload to be applied, which may be the additional weight or load that the structure is intended to support, and may determine the direction of the force exerted by the payload, and identify whether the payload is static or dynamic; static loads are constant, while dynamic loads change over time. For static loads, the knot-printing program 108 may only need to calculate the counterforce a single time, based on the constant weight and position. However, with dynamic loads, the knot-printing program 108 may need to calculate the counterforce at multiple points over a projected timeframe to account for potential acceleration forces, vibration, and stress cycling that can amplify the effective force on the knot over time. As such the knot-printing program 108 may analyze how the loads are distributed across the structure and whether they vary with time, as well as the angle at which the load is applied to the components. The knot-printing program 108 may use force component analysis to calculate the horizontal and vertical components of the load. Additionally, the knot-printing program 108 may identify any environmental factors that might affect the knots, which may include factors such as wind, snow, seismic forces, and other environmental conditions that may affect the structure.

In embodiments, the knot-printing program 108 may identify one or more intersections of the components where a knot is necessary or desirable to fasten two or more components together. In embodiments, the knot-printing program 108 may examine how the loads are distributed across the structural component, for example using a structural load simulation, and may identify component interactions where force transfer occurs between the components, such as where beams cross or where a vertical support element meets a horizontal element. The knot-printing program 108 may identify these critical points where force transfer occurs as intersections, which may be locations where the two or more components are physically interfacing with each other, and where a knot or fastening mechanism must be applied to resist the forces acting upon the two components at the critical point. In embodiments, the knot-printing program 108 may identify intersections using a machine learning model using, for example, random forest classification, that analyzes previous successful knot placements in historical data to identify optimal patterns of knot placement. The knot-printing program 108 may identify a single intersection, or may identify multiple intersections; the number of intersections that the knot-printing program 108 identifies may depend on the complexity of the structure formed by and/or comprising the components; when multiple intersections exist, for example where the structure formed by/comprising the components features multiple critical points where two or more components are interfacing, the knot-printing program 108 may prioritize the one or more intersections with the greatest forces acting upon them and/or the intersections comprising the most critical load-bearing structural features. In embodiments, the intersections may be pre-defined and pre-provided to knot-printing program 108 from an external source.

At 204, the knot-printing program 108 may calculate a counterforce based on the component data. Here, the knot-printing program 108 may sum up all of the loads acting on the components as defined within the force components comprising the component data to determine the total load the knot must support; this load is the force that the knot or fastening mechanism needs to counteract to maintain stability. Based on the calculated resultant force components, the knot-printing program 108 may calculate the counterforce required to maintain stability. In embodiments, this counterforce should be equal to or greater than the total load acting on the structural component, and should include both the vertical and horizontal components if the load is applied at an angle.

In embodiments, the knot-printing program 108 may add a policy-based safety margin to the calculated counterforce to ensure the knot or fastening mechanism can handle unexpected variations or overloads. The safety margin may be a configurable multiplier that knot-printing program 108 applies to the calculated counterforce to ensure that the knot can withstand unexpected forces, such as thermal expansion, in excess of the calculated counterforce without failing. The safety margin may be added based on thermal expansion properties of the knot material and/or the component material, and/or may be pre-provided to the knot-printing program 108 from an external source. In embodiments, the safety margin may be based on the criticality of the components, where criticality may be a number or classification associated with the intersection, the components, and/or the structure formed by the components, and which represents the importance of a given intersection, component, and/or structure and the need to ensure structural integrity of the knot. For example, structures comprising medical devices might require a 2.0×safety factor while furniture might only require a 1.3×safety multiplier, representing the fact that failure of a medical device is more likely to result in harm than failure of furniture. In embodiments, knot-printing program 108 may access a pre-provided database or file comprising components and/or intersections, their applications, the criticality associated with those applications, and the associated safety margin to apply.

In an exemplary embodiment, the knot-printing program 108 may employ the principles of static equilibrium to analyze the force components on structural components and calculate the counterforce required to maintain stability. The key equation to determine stability is that the sum of all forces in any direction (horizontal and vertical) must equal zero, and the sum of all moments (torques) about any point must equal zero. A mathematical representation of this concept is depicted as follows:

Sum of Forces in the Vertical Direction (Equilibrium in the Y-axis):

$$\sum Fy = 0$$

This equation states that the sum of all vertical forces acting on the structural component should be zero for vertical equilibrium.

Sum of Forces in the Horizontal Direction (Equilibrium in the X-axis):

$$\sum Fx = 0$$

This equation states that the sum of all horizontal forces acting on the structural component should be zero for horizontal equilibrium.

Sum of Moments about a Point (Equilibrium of Torques):

$$\sum τ = 0$$

This equation states that the sum of all torques (moments) about any point should be zero for rotational equilibrium. When considering moments, it is important to account for the perpendicular distance (lever arm) from the point of rotation.

To calculate the counterforce required for stability, the knot-printing program 108 may employ the following equations, considering the specific forces acting on the structural component:

The knot-printing program 108 may analyze the specification and profile of the structural components to calculate a Self-Weight (W_self), and calculate the vertical force due to the self-weight of the structure using the formula:

$$W\_self = m * g$$

Where W_self is the vertical force due to self-weight, m is the mass of the structure, and g is the acceleration due to gravity (approximately 9.81 m/s²). Based on the design specification, the knot-printing program 108 may calculate the Payload (W_payload), and determine the vertical force on the components due to the payload or external load. The knot-printing program 108 may consider any additional forces like wind, snow, or seismic forces. These forces can vary significantly based on the location of the knot printing device and the specifics of the environment.

In an exemplary embodiment, if the load is applied at an angle other than purely vertical, the knot-printing program 108 may decompose the forces exerted by the load into their vertical and horizontal components, and may use trigonometry to calculate these components as follows:

$$Vertical Component ( F\_vertical ) = W\_payload * sin ( θ ) \\ Horizontal Component ( F\_horizontal ) = W\_payload * cos ( θ )$$

The knot-printing program 108 may calculate the total vertical force acting on the structural component as follows:

$$\sum Fy = W\_self + F\_vertical + ( additional environmental forces , if any )$$

The knot-printing program 108 may calculate the total horizontal force acting on the structural component as follows:

$$\sum Fx = F\_horizontal$$

The knot-printing program 108 may calculate the counterforce that balances the total vertical and horizontal forces to bring stability to the components, as follows:

$$Counterforce ( F\_counter ) = - \sum Fy i + \sum Fx j$$

Here, i and j represent the unit vectors in the x and y directions, respectively. The negative sign indicates that the counterforce should act in the opposite direction of the net force acting on the structure.

When an object experiences a change in temperature, the object expands or contracts according to its coefficient of linear or volumetric expansion. The same concept can be applied to a circular ring, considering its circumference and the material from which it is made.

In embodiments, the invention may apply the following formula to calculate the change in circumference of a single knot (ΔC) due to temperature change:

$$Δ C = α * C * Δ T$$

### Where:

ΔC is the change in circumference.
α is the coefficient of linear expansion of the material.
C is the original circumference of the ring.
ΔT is the change in temperature in degrees Celsius or Kelvin.
   To calculate the force generated around the circumference, the knot-printing program 108 may use Hooke's Law, which states that the force (F) required to compress or extend a material is directly proportional to the change in length and the material's modulus of elasticity (E). For a ring, the force will act circumferentially:

$$F = ( α * C * Δ T ) * E$$

### Where:

F is the force generated around the circumference.
α is the coefficient of linear expansion of the material.
C is the original circumference of the ring.
ΔT is the change in temperature in degrees Celsius or Kelvin.
E is the modulus of elasticity of the material.
   The force generated may depend on the material of the knot (characterized by its modulus of elasticity and coefficient of linear expansion), the initial circumference of the ring, and the magnitude of the temperature change.

In embodiments, the knot-printing program 108 may employ a structural load simulation to model and sum up the relevant forces acting on the components. The structural load simulation may be a finite element analysis tool that models how forces distribute throughout the components when under stress. The structural load simulation may help the knot-printing program 108 predict exactly where stresses will concentrate in the components and how much force the knot needs to withstand at each specific point, rather than making general assumptions about load distribution. The knot-printing program 108 may utilize the simulation software to determine how much counterforce can be generated by a single knot, for example in the case where, if the knot material, or material used for creating the 3D-printed knot, is thermally expanded, and cools down, thermally contracting until it tightly grips the components. In other words, the knot-printing program 108 may use simulation software to model the force generated around the circumference of a circular knot when it cools down and grips the components after being thermally heated, causing expansion. Based on the simulation, the knot-printing program 108 may also consider the expansion of the components at the intersection where the knot material is laid to create a knot; in heating the knot material to 3D-print a knot onto the intersection, the knot-printing program 108 may necessarily heat the material comprising the components; the knot-printing program 108 may therefore employ the simulation to estimate the thermal expansion of the material comprising the components, and may compensate for the estimated thermal expansion by applying a pre-calculated safety margin factor that accounts for material expansion properties, by adding calibration inputs provided from the user as necessary, and/or through a historical learning process by which the knot-printing program 108 refines adjustments based on previous successful prints with similar materials as recorded in historical data.

At 206, the knot-printing program 108 may select a knot configuration based on the component data. The knot configuration may be a plan or schematic representing the knot or knots to be printed onto the intersection to generate the required counterforce to securely join the components together. The knot configuration may, in embodiments, be a file formatted such that the knot printing device may accept the file and create a printed knot configuration based on the knot configuration encoded within the file. The knot-printing program 108 may identify components that require fastening, as well as the exact positions for the application of the 3D printed knot or knots, through a combination of analysis and structural assessment; for example, the knot-printing program 108 may use computer vision techniques to identify component intersections, may apply edge detection methods to locate where components meet, and then may calculate the stress distribution at each intersection, for example using finite element analysis, to determine the optimal knot placement. The knot-printing program 108 may determine a knot that applies the calculated counterforce to the position, or intersection, based on the physical size, shape, and arrangement of the components, as well as the properties of the component material and the knot material.

In embodiments, the knot configuration may comprise the tightness of the knot or knots; the tightness may be a function of the circumference of the knot and the properties of the knot material with respect to thermal expansion or contraction. The smaller the circumference and the greater the thermal contraction, the tighter the knot; the tighter the knot, the greater the counterforce applied to the components, and the more secure the connection. However, a knot can only be as tight as the material strength of the knot material and the thickness of the knot material's diameter allows; if a tight knot is too thin and/or made from too weak a material, the knot may fail, and the components may fall apart. As such. the knot-printing program 108 may consider the material properties of the knot material in determining how large to make the circumference of the knot based on the thermal contraction of the knot material, what temperature to heat the knot material to in order to achieve the necessary thermal expansion and subsequent contraction, and how thick to make the diameter of the knot to ensure that the knot is structurally strong enough to withstand the stress of applying the required counterforce. In embodiments, the knot-printing program 108 may consider the material properties of multiple potential knot materials to identify one or more suitable knot materials that can provide the required physical properties to apply the counterforce to the components, and select one suitable knot material for use in the knot printing device to 3D print the knot around the components.

In embodiments, the knot configuration may comprise the type of knots. A knot may be a continuous strand of thermoplastic material that secures components through a combination of wrapping, crossing, and interlocking geometries. The knot-printing program 108 may choose a knot based on the counterforce that the knot produces considering the specific requirements and specification of the structural components, including the material, load capacity, and the angle at which the load is applied, as different knots are more effective at producing counterforce in different scenarios. For example, simple loops with multiple wraps may be most effective for securing basic parallel joints, figure-eight configurations may be most effective for securing perpendicular components, specialized crossover patterns may be most effective for securing triangular structures. Square knots may be most effective at joining components under tension in the same axis, a clove hitch may work best for perpendicular intersections with dynamic loads, figure-eight knots may be most effective at ensuring the stability of components affected by significant rotational forces, and multiple wrap loops may be most effective for joining components with significant size differences. In embodiments, the knot-printing program 108 may choose a knot based on a historically learnt knot specification, which may comprise a database of previously successful knot designs and their performance metrics across different load conditions. The knot-printing program 108 may reference the historically learnt knot specification to identify knots and knot configurations that performed well in structural situations similar to present conditions.

In embodiments, for example based on the counter force created by a single knot and the required counter force, the knot-printing program 108 may identify the number of knots that will be required for the creation of a knot configuration at the intersection strong enough to fasten the components; in embodiments, the knot-printing program 108 may identify multiple types of knots that will be required for the creation of the knot configuration and the required number of each type of knot, such that the knot configuration for an intersection may comprise multiple types of knots. In embodiments, the knot-printing program 108 may calculate a number of wraps comprising the knots; the more wraps comprising a given knot, the greater the counterforce the knot produces. The knot-printing program 108 may calculate a number of wraps of the knot to make around the structural components, taking into account the thickness or diameter of the knot for each wrap, such that once the knot cools down, the required gripping strength is achieved.

At 208, the knot-printing program 108 may 3D-print the knot configuration to connect the two 3D-printed components. Here, the knot-printing program 108 may transmit the knot configuration to the knot printing device, which then creates the knot around the structural components according to the knot configuration. During the printing process, the knot printing device may apply heat to the knot material, such that the knot material is in an expanded and melted state; the knot printing device may, using a flexible print head on an articulated mounting and/or a robotic holding system, navigate in a 360-degree arc of motion around the intersection to apply a continuous strand of knot material to the exterior surface of the intersection; if the knot configuration specifies a knot comprises multiple wraps, the knot printing device will circumnavigate the exterior surface of the intersection as many times as the knot configuration specifies wraps, each pass wrapping the strand of melted knot material around the intersection. Once the specified number of wraps has been achieved, the knot printing device may melt the two ends of the strand of knot material together, and/or may print the ends of the strand into a geometry that will tighten into a conventional knot once cooled, such that the two ends are tied together and secured using friction, as in a conventional knot made of rope or fiber. Once printed, the knot will cool and contract, until the knot produces the counterforce specified in the knot configuration, and thereby achieves the level of tightness and gripping strength necessary to maintain the structural integrity of the components it secures.

In embodiments, while 3D printing the knot around the structural components, the proposed system may employ a second robotic system to temporarily hold the structural components until the 3D printed knot attains the required gripping strength after it cools down. Subsequently, the second robotic system will release the structural components; in embodiments, for example where the knot-printing program 108 comprises a temperature sensor such as a remote thermometer or infrared camera, the knot-printing program 108 may release the structural components responsive to determining that the temperature has fallen below a threshold that represents the temperature at which the knot material has fully solidified. In embodiments, for example where the knot-printing program 108 comprises a sensor capable of measuring the surface geometry of the knot, such as a camera or laser scanner, the knot-printing program 108 may release the structural components responsive to determining that the circumference of the knot has contracted to or below a size threshold that represents the circumferential size to which the knot material has fully contracted. Responsive to determining that the temperature and/or size of the knot has fallen below their respective thresholds, the knot-printing program 108 may operate the robotic holding system to release one or more clamps holding the components. In embodiments, the knot-printing program 108 may operate the robotic holding system to release all but one of the clamps holding the components, such that the now-fastened components are held by only a single point of contact.

Referring now to FIG. 3, an exemplary embodiment 300 of a knot printing device 146 is depicted according to at least one embodiment. Here, the knot printing device 146 comprises a print head 302, which receives a printing material 304 from a material filament spool 306. The temperature control units 308 maintain a temperature that is higher than the melting point of the knot material to melt the knot material. In embodiments, the temperature control units 308 maintain a temperature that is higher than the melting point of the knot material, but which is lower than the melting point of the component materials, to avoid melting the component materials. The knot-printing program 108 may modify the temperature within that range to create and maintain optimal conditions for extrusion. Once heated, the knot material is extruded from the print head 302 onto an intersection between a first component 310 and a second component 312 to create a knot 314, which, as first component 310 and second component 312 are largely parallel, may be a simple wrap. The extrusion process may be monitored in real-time by a sensor 316, which may be a camera or other sensor. The first component 310 and the second component 312 may be held in position by a robotic holding system 318 comprising multiple articulable arms with force-feedback sensors that are operable by the knot-printing program 108 to dynamically adjust their grip to respond to changing tensions as the knot 314 solidifies. The print head 302 may be secured to the knot printing device 146 by an articulated mounting 320 that allows the print head 302 multi-axis motion such that the print head 302 may move around and even completely circumnavigate the intersection of first component 310 and second component 312 to print the knot 314 on all surfaces of the intersection in a 360-degree arc.

It may be appreciated that FIGS. 2-3 provide only illustrations of individual implementations and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for 3D-printing a knot to fasten two components together, the method comprising:
analyzing, by one or more sensors, a plurality of components to create component data;
calculating a counterforce at an intersection of the components based on the component data;
selecting a knot configuration based on the component data; and
printing, by a knot printing device, the knot configuration onto the intersection of the components using an additive manufacturing process.

2. The method of claim 1, further comprising:
holding, by a robotic system, the components, and the printed knot configuration; and
responsive to determining that the printed knot configuration has cooled sufficiently to achieve the calculated counterforce, releasing, by the robotic system, the components, and the printed knot configuration.

3. The method of claim 1, wherein the selecting comprises selecting a type, number, thickness, and number of wraps of a knot required to achieve the calculated counterforce.

4. The method of claim 1, wherein the selecting comprises determining a circumference and material of a knot to achieve the calculated counterforce through thermal contraction.

5. The method of claim 1, further comprising:
identifying the intersection at a critical point where force transfer occurs between two interfacing components.

6. The method of claim 1, wherein the counterforce comprises a safety margin based on a criticality of the intersection.

7. The method of claim 1, wherein the knot printing device comprises a print head attached to an articulated mounting enabling the print head to circumnavigate the intersection to print the knot configuration.

8. A computer system for 3D-printing a knot to fasten two components together, the computer system comprising:
a knot printing device, one or more sensors, one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
analyzing, by the one or more sensors, a plurality of components to create component data;
calculating a counterforce at an intersection of the components based on the component data;
selecting a knot configuration based on the component data; and
printing, by the knot printing device, the knot configuration onto the intersection of the components using an additive manufacturing process.

9. The computer system of claim 8, further comprising:
holding, by a robotic system, the components, and the printed knot configuration; and
responsive to determining that the printed knot configuration has cooled sufficiently to achieve the calculated counterforce, releasing, by the robotic system, the components, and the printed knot configuration.

10. The computer system of claim 8, wherein the selecting comprises selecting a type, number, thickness, and number of wraps of a knot required to achieve the calculated counterforce.

11. The computer system of claim 8, wherein the selecting comprises determining a circumference and material of a knot to achieve the calculated counterforce through thermal contraction.

12. The computer system of claim 8, further comprising:
identifying the intersection at a critical point where force transfer occurs between two interfacing components.

13. The computer system of claim 8, wherein the counterforce comprises a safety margin based on a criticality of the intersection.

14. The computer system of claim 8, wherein the knot printing device comprises a print head attached to an articulated mounting enabling the print head to circumnavigate the intersection to print the knot configuration.

15. A computer program product for 3D-printing a knot to fasten two components together, the computer program product comprising:
one or more computer-readable tangible storage medium and program instructions stored on at least one of the one or more tangible storage medium, the program instructions executable by a processor to cause the processor to perform a method comprising:
analyzing, by one or more sensors, a plurality of components to create component data;
calculating a counterforce at an intersection of the components based on the component data;
selecting a knot configuration based on the component data; and
printing, by a knot printing device, the knot configuration onto the intersection of the components using an additive manufacturing process.

16. The computer program product of claim 15, further comprising:
holding, by a robotic system, the components, and the printed knot configuration; and
responsive to determining that the printed knot configuration has cooled sufficiently to achieve the calculated counterforce, releasing, by the robotic system, the components, and the printed knot configuration.

17. The computer program product of claim 15, wherein the selecting comprises selecting a type, number, thickness, and number of wraps of a knot required to achieve the calculated counterforce.

18. The computer program product of claim 15, wherein the selecting comprises determining a circumference and material of a knot to achieve the calculated counterforce through thermal contraction.

19. The computer program product of claim 15, further comprising:
identifying the intersection at a critical point where force transfer occurs between two interfacing components.

20. The computer program product of claim 15, wherein the counterforce comprises a safety margin based on a criticality of the intersection.
